(19) United States
(12) Patent Application Publication
(10) Pub. No.: US 2014/0032500 A1
(43) Pub. Date: Jan. 30, 2014

(54) INTERMITTENT CONNECTIVITY TOLERANT REPLICATED DOCUMENT COLLABORATION WORKSPACES

(71) Applicants: Pat Wibbeler, Rocklin, CA (US); Steve Dakin, San Jose, CA (US); Barnaby James, San Jose, CA (US); Randy L. Swineford, San Jose, CA (US)

(72) Inventors: Pat Wibbeler, Rocklin, CA (US); Steve Dakin, San Jose, CA (US); Barnaby James, San Jose, CA (US); Randy L. Swineford, San Jose, CA (US)

(73) Assignee: Adobe Systems Incorporated

(21) Appl. No.: 11/931,885

(22) Filed: Oct. 31, 2007

(51) Int. Cl. G06F 17/30

(52) U.S. Cl. 707/661; 707/E17.001; 707/741

(57) ABSTRACT

Various embodiments provide one or more of systems, methods, and software that replicate a document workspace, including comments and participant information. Some embodiments allow participants to view and manipulate comments while a network connection is not available. Additionally, the document typically contains knowledge of a comment repository holding comments submitted by participants which eliminates a need for a comment discovery mechanism. Some embodiments provide various means for viewing, modifying, and adding comments even while disconnected from the network. Comments made while disconnected may later be pushed to the repository when a connection becomes available. Further embodiments may provide a background notification via a user interface to notify participants when new comments are received or new reviewers are added.

### BACKGROUND INFORMATION

Many documents are generated in today's electronic society. These documents are often created by one individual, but are subject of review by others. Documents to be reviewed are commonly created and then forwarded to others for review. Such reviewers typically make corrections and additions to the document under review and may also add comments, markups, and other annotations. The modified document is then sent back to the document creator. The document creator then has the task of sorting through each of possibly many modified document copies and consolidating the comments into a single copy of the document. Some comments and modifications may be the same between the modified document copies, but the creator of the document still needs to sort through all of the comments and make such a determination. Reviewers making the same modification or comment are also duplicating their efforts. Further, keeping track of a source of the modifications and comments becomes increasingly difficult as the number of reviewers increases.

Distributing a document for review has previously been done by emailing a draft copy to each reviewer. In such scenarios, each reviewer performs the reviewing task in parallel and the document creator must put all of the reviewer input back into a single document. Other solutions have been developed and include centralized server or peer-to-peer architectures. However, these solutions require an active network connection for reviewers and the document creator to collaborate.

### BRIEF DESCRIPTION OF THE DRAWINGS

FIG. 1 is a logical block diagram of a system according to an example embodiment.

FIG. 2 is a block diagram of a system according to an example embodiment.

FIG. 3 is a block flow diagram of a method according to an example embodiment.

FIG. 4 is a block flow diagram of a method according to an example embodiment.

FIG. 5 is a block flow diagram of a method according to an example embodiment.

FIG. 6 is a block diagram of a computing device according to an example embodiment.

### DETAILED DESCRIPTION

Various embodiments described in detail below provide one or more of systems, methods, and software to asynchronously replicate a document workspace, including comments and participant information. Typical embodiments allow participants to view and manipulate comments while a network connection is not available. The document may be distributed to participants via whatever means are convenient, and each participant is effortlessly aware of new participants. Additionally, the document typically contains knowledge of a comment repository holding comments submitted by all participants which eliminates a need for a comment discovery mechanism. Some embodiments provide various means for viewing, modifying, and adding comments even while disconnected from the network. Comments made while disconnected may later be pushed to the repository when a connection becomes available. Further embodiments may provide a background notification via a user interface to notify participants when new comments are received or new reviewers are added. These and other embodiments are described in greater detail below.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

As used herein, a document may be a page description language document, such as a document encoded in the Portable Document Format (“PDF”) which may be viewed and modified in one of the ADOBE® ACROBAT® programs available from ADOBE SYSTEMS INCORPORATED. A document may also be an electronic word processing file, spreadsheet file, markup language file, slide-show type presentation file, text file, or other file type which may be in need of review by one or more other participants.

Comments, as used herein, may be textual or graphical and may include electronically handwritten markups, such as through use of a touch screen, pen-enabled computing device, or other type of markup cable of conveying information to other document review participants.

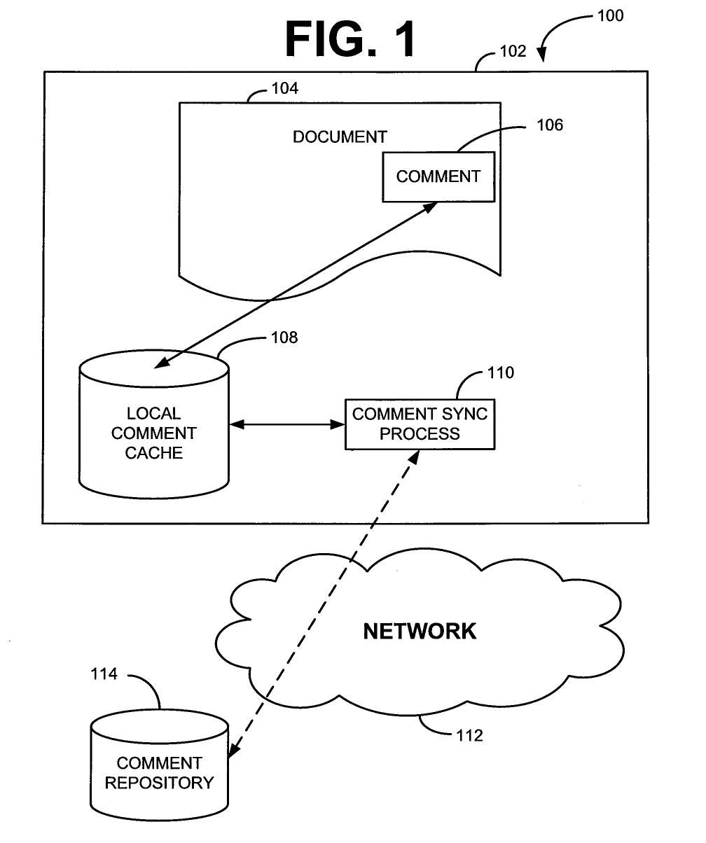

A document is typically submitted for review in the embodiments described herein by a review initiator. The initiator submits a document for review to participants. A participant is an individual who participates in the review. An initiator is also a participant, but an initiator is differentiated from a participant by the fact that the initiator submitted the document for review. FIG. 1 provides a logical block diagram of a system according to an example embodiment that allows an initiator to submits a document for review to participants.

FIG. 1 is a logical block diagram of a system 100 according to an example embodiment. The example system 100 includes a client 102 computing device, such as a personal computer, handheld computing device, or other computing device. The client 102 includes a document viewing and authoring/manipulation application (not illustrated) that allows a user to view and author, or otherwise manipulate, a document 104. For example, the user may use the document viewing and authoring/manipulation application to view the document 104 and add a comment 106. Although only a single client 102 is illustrated, typically embodiments include two or more clients 102.

In some embodiments, when a user adds the comment 106 to the document 104, a representation of the comment 106 is stored by the document viewing and authoring/manipulation application in a local comment cache 106. The local comment cache 108 is a location in a memory or storage device of the client 102 capable of holding data. The comment 106, when stored in the local comment cache 108, typically includes data encoded in a format that may be processed by the document viewing and authoring/manipulation application on the client 102 and by a document viewing and authoring/manipulation application on client computing device of another participant. For example, the comment 106, when stored in the local comment cache 108, may include textual or graphical data, a reference to a location in the document 104 where the comment was placed or inserted by a participant, and a document identifier identifying the document 104 to which the comment 106 is associated. Although only a single comment 106 is illustrated, many comments may be associated with and displayable within the document 104.

The client 102 also includes a comment synchronization process 110. In some embodiments, the comment synchronization process 110 is operative to replicate comments, such as comment 106, from the local comment cache 108 to a comment repository 114 over a network 112. The comment repository 114 is a storage location accessible via the network 112. The storage location may be a sever, a database, or other storage mechanism capable of receiving, storing, and serving data to the comment synchronization process 110. The comment repository 114 receives comments from the comment synchronization process 110 of the client 102 and of other clients. The comment repository 114 may hold comments generated during review of the document 104 and other documents. The comment synchronization processes 110 of the client 102 and other clients replicate comments from their respective local comment caches 108 to the comment repository. The comment synchronization processes 110 are also operative to retrieve copies of comments from the comment repository 114 for documents being reviewed on the respective clients, such as document 104 on client 102. Some typical embodiments may include a remote server housing the comment repository 114 that serves as a central repository for document comments and reviewer information, such as the name, title and email address of each reviewer. The centralized nature of the comment repository 114 makes it the single source of truth for the workspace state of each of one or more documents under review.

In typical embodiments, the client 102 is intermittently connected to the network 112. At times when the client 102 is not connected to the network 112, documents may still be reviewed in the document viewing and authoring/manipulation application because comments submitted by a local participant and by other participants are replicated locally in the local comment cache 108. Thus, participants may continue to add comments to documents under review, such as document 104, while not connected. Such comments will be cached in the local comment cache 108. Upon establishing, or reestablishing, a connection to the network 112, the comment synchronization process 110 will post comments received or modified in the local comment cache 108, while not connected to the network, to the comment repository 114. Further, comments posted to the comment repository 114 while the client 102 is not connected will be retrieved and replicated in the local comment cache 108. Thus, using such embodiments, review participants are able to review documents at a location of their choosing, such as while on an airplane or away from an office, and later synchronize with other participants. Also, participants are able to review documents when connected to a relatively poorly functioning network.

Documents submitted for review in some system 100 embodiments may be distributed to participants by any number of means such as email, storing on a participant accessible server or website, on one or more disks, or via other suitable means. The actual means of distribution in typical embodiments is essentially of no concern because a document submitted for review typically includes a unique document identifier and an identifier of a location of the comment repository 114. Thus, when a participant opens the document, the application opening the document extracts the identifier of the location of the comment repository 114, such as a Uniform Resource Identifier (“URI”) to locate the comment repository 114, and the unique document identifier to identify comments, if any, in the comment repository 114 associated with the document being opened. Thus, the properties of a document submitted for review enable to participants to share a collaborative commenting workspace associated with the document.

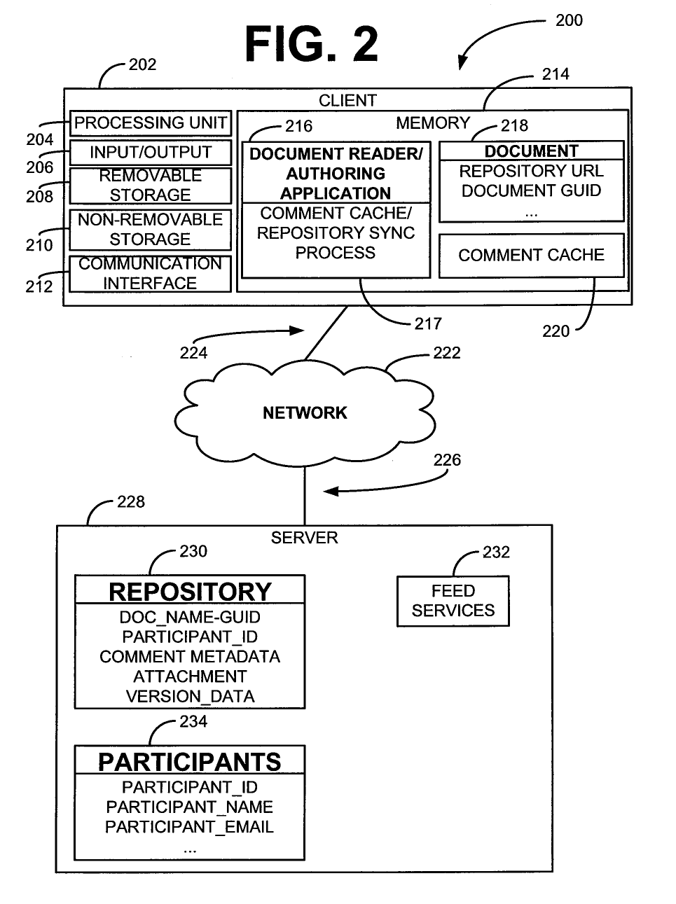

FIG. 2 is a block diagram of a system 200 according to an example embodiment. The system 200 includes a client 202 that may be connected 224 to a network 222. The system 200 further includes a server 228 also connected 226 to the network 222. Although only a single client 202 is illustrated, it is readily apparent that any number of clients 202 may be included in various embodiments of the system 200.

The client 202 typically includes a processing unit 204, input and output devices 206, optional removable storage devices 208, non-removable storage 210 such as a hard drive, a communication interface 212 such as a network interface card, and a memory 214. The memory 214 typically holds software and data that may be processed by the processing unit 204 and retrieved from removable storage 208, non-removable storage 210, and/or over the communication interface 212. The software in the memory 214, in typical embodiments of the present subject matter, includes a document reader/authoring application 216. The document reader/authoring application 216 typically includes user interfaces, menu options, and other tools that allow a user to create, view, and modify documents and add comments thereto.

The memory 214 may also hold one or more documents and a comment cache 220. Although the document 218 and the comment cache 220 are illustrated in memory 214, one or both may also or alternatively be stored in non-removable storage 210 or removable storage 210.

The document reader/authoring application 216 is operable to open the document 218 and determine if the document 218 has been submitted for review by a review initiator. In such instances, the document may include a Uniform Resource Identifier (“URI”), such as a Uniform Resource Locator (“URL”), of a comment repository that is setup to hold comments from review participants and a unique identifier of the document to be reviewed, such as a Globally Unique Identifier (“GUID”). In such embodiments, the document reader/authoring application 216 may identify that the document 218 has been submitted for review, extract the URL and GUID from the document 218, and pass the URL and GUID to comment cache/repository synchronization process 217. The comment cache/repository synchronization process 217 may be a part of the document reader/authoring application 216 or an ancillary module, such as a plug-in or standalone application that provides services to the document reader/authoring application 216.

In a typical embodiment, when the document reader/authoring application 216 passes the URL and GUID to the comment cache/repository synchronization process 217, the comment cache/repository synchronization process 217 determines if the communication interface of the client 202 is connected 224 to the network 222. If not connected, the comment cache/repository synchronization process 217 will attempt to connect at a later time or when instructed to by a command from a user of the client 202. If connected, the comment cache/repository synchronization process 217 accesses the comment repository at the URL, such as repository 230 on server 228, over the network 222 to retrieve comments associated with the document identified by the GUID.

In some embodiments, the server 228 is a database server under control of a database management system holding data in tables, such as a repository table 230 and a participant table 234. The comment cache/repository synchronization process 217 in such embodiments, may simply query the database tables to retrieve the comments associated with the document GUID.

In other embodiments, the server 228 provides access to the repository 230 through feed services 232. The feed services 232, in various embodiments, may include one or more of Really Simple Syndication (“RSS”) services, Atom feed services, Outline Processor Markup Language (“OPML”) based feed services, Web-based Distributed Authoring and Versioning (“WebDAV”) based services, or other syndication services. In such syndication enabled embodiments of the server 228, the comment cache/repository synchronization process 217 on the client 202 is enabled to communicate with one or more of the feed services 232 to post and retrieve comments to synchronize the comment cache 220 on the client 202 when connected 224 to the network 222. In some such embodiments, when the comment cache/repository synchronization process 217 first receives a URL and document GUID, the comment cache/repository synchronization process 217 subscribes to comments posted to the repository 230.

In some embodiments, the server 228 may store and/or provide data via a database management system or the feed services 232 encoded in an eXtensible Markup Language (“XML”) format. The XML encoded data, when received by the comment cache/repository synchronization process 217 may then store the data as received in the comment cache 220 in the memory 214 of the client 202 if the document reader/authoring application 216 is enabled to parse and process data in the XML format. In other embodiments, the comment cache/repository synchronization process 217 may translate the data into a format that may be processed by the document reader/authoring application 216 to place comments within the document 218 and present them to a user.

The repository 230 and participants 234 tables illustrated within the server 228, as mentioned above, may be tables within a database. In other embodiments, the repository 230 and participants 234 tables may be flat files or other data structures stored within a memory or storage device of the server 228 that may be accessed by the feed services 232 or other service or process that is responsive to the comment cache/repository synchronization process 217 of the client 202.

The repository 230 table may include a record for each comment received. An example of such a record may include a document name and identifier field as a key to uniquely identify a document to which an individual record is applicable to. Such a record may also include a participant identifier that references a row in the participants table 234 identifying a participant submitting the comment of the particular record. Each repository record also includes a field to hold a comment. A comment may be stored as metadata in an open format. The open format, in some embodiments, enables the repository to be application agnostic meaning that regardless of the type of document under review or application used to create, modify, or comment on a document, the repository can hold the comment data. In some embodiments, a comment record may also include an attachment field. The attachment field may be a BLOB holding the actual attachment or a reference to data storage location wherein the attachment is stored. In some embodiments, a comment record in the repository 230 may also include version data. Such data may be used to identify if a comment has been edited.

The network 222, in various embodiments, may include one or more of the Internet, a local area network, a wide area network, a storage or system area network, a virtual private network, or other network type depending on the environment and requirements of the particular embodiment. The network 222 may be connected to 224, 226 via wired or wireless connections depending on the infrastructure components of the particular environment within which the embodiment is instantiated on or to which a client 202 connects.

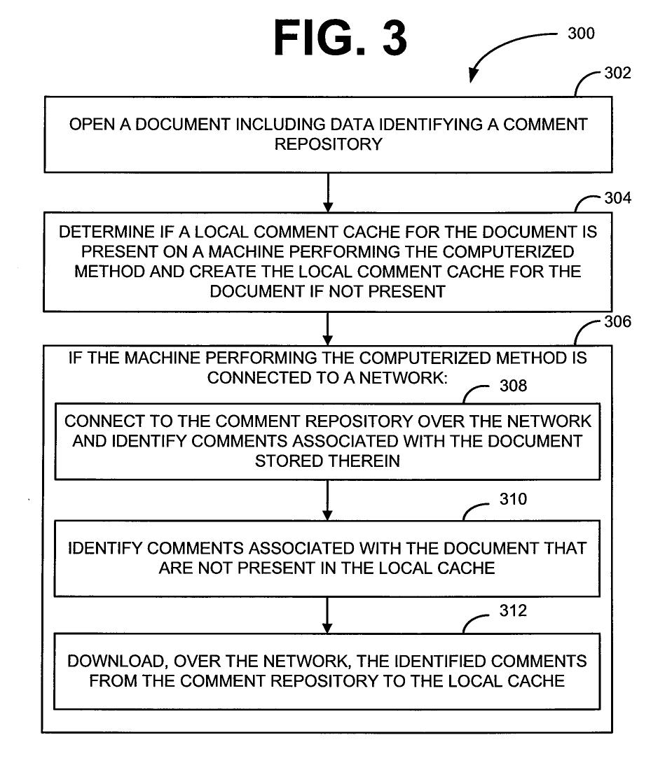

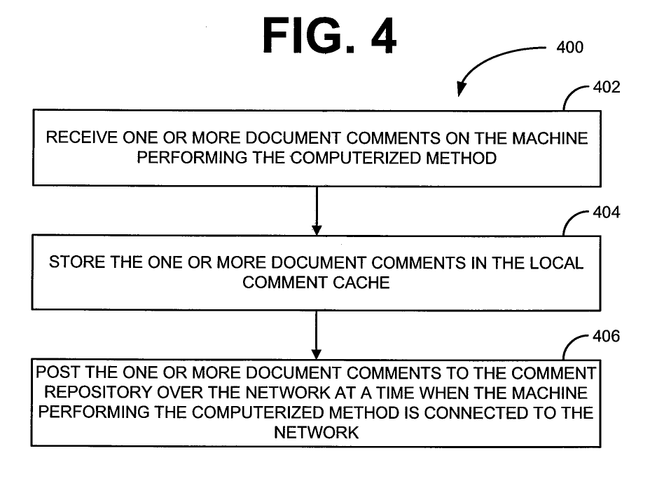

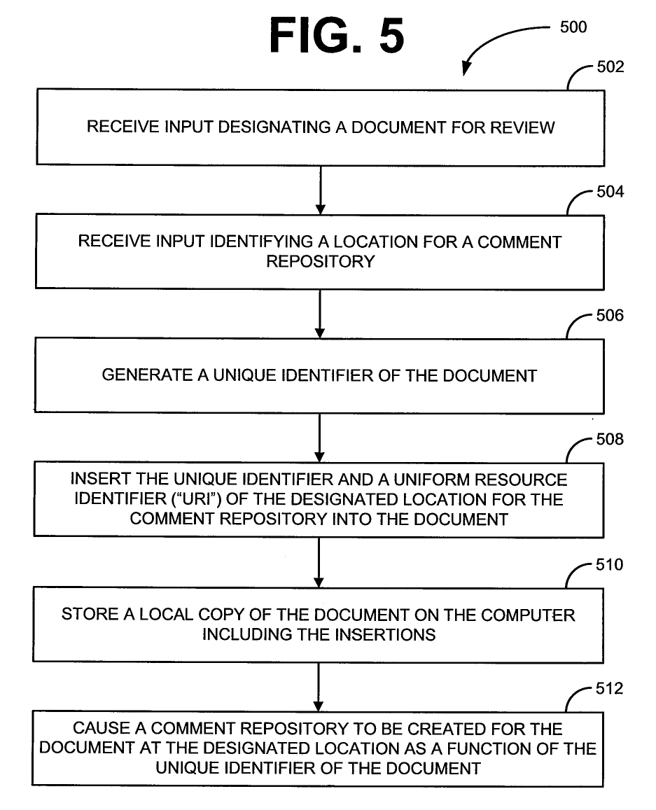

Further detail as to the operation of the system 100 of FIG. 1 and the system 200 of FIG. 2 according to some embodiments is illustrated and discussed with regard to FIG. 3, FIG. 4, and FIG. 5.

FIG. 3 is a block flow diagram of a method 300 according to an example embodiment. The example method 300 is a method of opening a document designated for collaborative review utilizing a comment repository. The method 300 includes opening 302 a document including data identifying a comment repository. When opening 302 the document, or shortly thereafter, the method 300 includes determining 304 if a local comment cache for the document is present on a computing device performing the method and creating the local comment cache for the document if one is not present. The method further includes determining 306 if the computing device performing the method is connected to a network. If the computing device is connected to the network, or upon establishment of a connection to the network, the method 300 includes connecting 308 to the comment repository over the network and identifying comments associated with the document stored therein. Next, the method includes identifying 310 comments associated with the document that are not present in the local cache and downloading 312 those identified comments from the comment repository to the local cache.

In some embodiments, the document data identifying the comment repository includes a globally unique identifier (“GUID”) of the document and a Uniform Resource Identifier (“URI”), such as a URL, of the comment repository.

In typical embodiments of the method 300, a comment includes one or more of data identifying a location within the document of where the comment is to be located, a drawing markup of at least a portion of the document, a textual comment, a stamp, a file attachment, and a digital signature. The data identifying a location within the document of where the comment is to be located may include a reference to a document page or other unit of the document and coordinates, such as X and Y coordinates, of where the comment is to be placed when displayed to a user.

In the method 300, identifying 310 comments associated with the document that are not present in the local cache may include identifying an updated comment if the updated comment is not present in the local cache. Such identification may be performed with reference to a version identifier of a particular comment, a text or other type of comparison, looking at a data/time stamp of the comment, or via other means of difference identification.

After the document is opened and displayed, comments from the local comment cache may be processed and overlaid upon the document for display. When new comments are retrieved from the comment repository and stored in the local comment cache, those comments may automatically be overlaid and displayed as well. However, in some embodiments, when one or more new comments are available in the comment repository, a user maybe prompted to specify whether or not to download the new comments and/or whether or not to display the comments if downloaded. If not downloaded or displayed, a user may later select a control, menu item, or other element of an application displaying the document to cause the comments to be downloaded and/or displayed.

In some embodiments, of the method 300, connecting to the comment repository 308 may include connecting to a feed of a syndication service of a network to retrieve data identifying comments associated with the document stored therein to facilitate the identifying of comments associated with the document that are not present in the local cache. In some such embodiments, the syndication service is a Really Simple Syndication (“RSS”) service or other suitable syndication service as discussed above.

FIG. 4 is a block flow diagram of a method 400 according to an example embodiment. The example method 400 is a method of receiving a new comment within an application operable on a computing device to present a document submitted for review to a participant, caching the comment locally, and posting the comment to a comment repository. Typical embodiments of the method 400 include receiving 402 one or more document comments and storing 404 the one or more document comments in a local comment cache. The method 400 further includes posting 406 the one or more document comments to the comment repository over a network at a time when the computing device performing the method is connected to the network. In the event that the computing device is not connected to the network when the comment is ready for posting 406, the comment remains in the cache and the comment will be posted 406 at a later time when the computing device is connected to the network. The posting 406 may be attempted on a periodic basis that may be configured by a user or administrator. In other embodiments, the posting 406 may be attempted upon receipt of a user interface command, such as through a menu item selection, by a user.

FIG. 5 is a block flow diagram of a method 500 according to an example embodiment. The method 500 is an example of a method that may be performed on a computing device, such as by a document authoring or reading application, to initiate a document review by one or more other participants. The method 500 typically includes receiving 502 input designating a document for review and receiving 504 input identifying a location for a comment repository. The method 500 may also include generating 506 a unique identifier of the document and inserting 508 the unique identifier and a Uniform Resource Identifier (“URI”) of the designated location for the comment repository into the document. The unique identifier and URI may be inserted as metadata within the document. The method 500 further includes storing 510 a local copy of the document on the computer receiving the inputs received at 502, 504 and causing 512 a comment repository to be created for the document at the designated location as a function of the unique identifier of the document.

In some embodiments, upon receipt 504 of input identifying the location for the comment repository, the method 500 verifies the identified location for the comment repository is valid and operational. Such verification may include writing a file to the designated location for the comment repository and verifying the file was successfully written. The verification may further include deleting the file from the designated location for the comment repository and verifying the file was successfully deleted. If one or more of these verification procedures is not successful, such embodiments of the method 500 include requesting input designating a different location for the comment repository.

Some embodiments may further include receiving input identifying a distribution mode to distribute the document to reviewers. The input identifying the distributing mode may include input designating the distribution mode as a post to server accessible to other participants for download. In some embodiments, the input designating the distribution mode may include email. In some such embodiments, a user interface may present a listing of users that may be selected as participants. Following the selection of participants and upon selection of an action button or other user interface control, a copy of the document may be emailed by, or under the direction of, the document authoring or reading application.

In some embodiments, the method 500 may further include receiving input identifying one or more reviewers authorized to submit comments to the comment repository. In such embodiments, wherein causing 512 the comment repository to be created for the document includes submitting data identifying reviewers authorized to submit comments to the comment repository. In some of these embodiments, and others, when a participant is selected or otherwise designated as a participant in a document review, a notice may be sent to the participant informing the participant of the document awaiting review.

Some embodiments of the method 500 include periodically connecting to the comment repository when a network connection is available to synchronize a local comment cache with the comment repository. Some such embodiments often include receiving document comments and storing the comments in a local comment cache. The comments stored in the local comment cache may then be uploaded to the comment repository in a manner associating the uploaded comments with the document the comments are relevant to during a periodic or ad hoc connection to the comment repository. During such a connection, comments may be synchronized between the local comment cache and the comment repository.

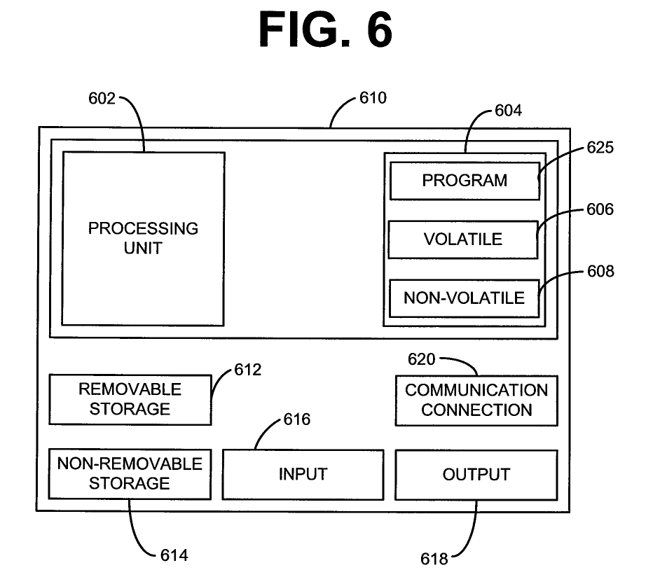

FIG. 6 is a block diagram of a computing device according to an example embodiment. In one embodiment, multiple such computer systems are utilized in a distributed network to implement multiple components in a transaction based environment. An object oriented, service oriented, or other architecture may be used to implement such functions and communicate between the multiple systems and components. One example computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 610. A hard drive, CD-ROM, and RAM are some examples of articles including a computer-readable medium. For example, a computer program 625 capable of performing all or a portion of one or more of the methods illustrated and described with regard to FIG. 3, FIG. 4, and FIG. 5.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A computerized method comprising:
opening a local copy of a document including data identifying a remote comment repository;
determining a local comment cache for the document is present on a machine performing the computerized method and creating a local comment cache for the document to store comments received locally as input and retrieved from the remote comment repository;
when the machine performing the computerized method is connected to a network:
connecting to the remote comment repository over the network and identifying comments associated with the document stored therein, at least one comment stored in the remote comment repository received over the network from another machine having a copy of the document local to the another machine;
identifying comments associated with the document that are not present in the local cache; and
downloading, over the network, the identified comments from the remote comment repository to the local cache; and
presenting, even at times when the machine performing the computerized method is disconnected from the network, a view of the comments stored in the local comment cache that were received locally as input and retrieved from the remote comment repository.

2. The computerized method of claim 1, wherein the document data identifying the remote comment repository includes:
a globally unique identifier of the document; and
a Uniform Resource Identifier (“URI”) of the remote comment repository.

3. The computerized method of claim 1, wherein a comment includes one or more of:
data identifying a location within the document of where the comment is to be located;
a drawing markup of at least a portion of the document;
a textual comment;
a stamp;
a file attachment; and
a digital signature.

4. The computerized method of claim 1, wherein identifying comments associated with the document that are not present in the local cache includes identifying an updated comment if the updated comment is not present in the local cache.

5. The computerized method of claim 1, further comprising:
displaying the document including the downloaded comments.

6. The computerized method of claim 1, wherein connecting to the remote comment repository includes connecting to a feed of a syndication service of a network to retrieve data identifying comments associated with the document stored therein to facilitate the identifying of comments associated with the document that are not present in the local cache.

7. The computerized method of claim 6, wherein the syndication service is a Really Simple Syndication (“RSS”) service.

8. The computerized method of claim 1, further comprising:
receiving the document from a review initiator.

9. The computerized method of claim 8, wherein the document is received via email.

10. The computerized method of claim 1, further comprising:
receiving one or more document comments on the machine performing the computerized method;
storing the one or more document comments in the local comment cache; and
posting the one or more document comments to the remote comment repository over the network at a time when the machine performing the computerized method is connected to the network.

11. A computer readable medium, with instructions thereon, which when executed, cause a computer to:
receive input designating a document for review;
receive input identifying a location for a comment repository;
generate an identifier of the document;
insert the unique identifier and a Uniform Resource Identifier (“URI”) of the designated location for the comment repository into the document;
store a local copy of the document on the computer receiving the inputs; and
cause a comment repository to be created for the document at the designated location as a function of the identifier of the document
receive document comments;
store the comments in a local comment cache; and
upload the comments from the local comment cache to the comment repository in a manner associated with the document during a periodic connection to the comment repository to synchronize the local comment cache with the comment repository
present, even at times when disconnected from the comment repository, a view of the received document comments stored in the local comment cache and retrieved from the remote comment repository while synchronizing the local comment cache with the comment repository.

12. The computer readable medium of claim 11, wherein the instructions when further executed cause the computer to:
receive input identifying a distribution mode to distribute the document to reviewers.

13. The computer readable medium of claim 11, wherein the instructions when further executed cause the computer to:
to receive input identifying one or more reviewers authorized to submit comments to the comment repository; and
wherein causing the comment repository to be created for the document at the designated location includes submitting data identifying reviewers authorized to submit comments to the comment repository.

14. (canceled)

15. (canceled)

16. The computer readable medium of claim 11, wherein the instructions when further executed cause the computer to:
write a file to the designated location for the comment repository;
verify the file was successfully written;
delete the file from the designated location for the comment repository;
verify the file was successfully deleted; and
request input designating a different location for the comment repository in the event that the file was not written or deleted successfully.

17. A system comprising:
one or more memory devices;
a network interface;
a comment cache in at least one of the memory devices to hold comments associated with a document;
a document presentation module operable to:
present documents via a user interface;
retrieve comments associated with a document displayed in the user interface from the comment cache if any are present in the comment cache and overlay the comments upon the displayed document; and
receive a comment to the document displayed via the user interface and store the comment in the comment cache; and
a comment cache synchronization module operable to synchronize comments held in the comment cache with comments stored in a comment repository over the network interface.

18. The system of claim 17, wherein the comment cache synchronization module is further operable to:
connect to the comment repository over the network interface when the network interface is connected to a network.

19. The system of claim 17, wherein the comment cache synchronization module is operable to:
connect to the comment repository at a location identified in the document to synchronize comments associated with the document between the comment cache and the comment repository as a function of an identifier of the document.

20. The system of claim 17, wherein:
the document presentation module is operable to extract a Uniform Resource Identifier (“URI”) and document identifier from the document and submit the URI and unique document identifier to the comment synchronization module; and
the comment synchronization module, upon first receipt of the URI and document identifier:
subscribes to a subscription service of the comment repository at the location identified by the URI to synchronize comments between the comment cache and the comment repository for the document identified by the document identifier.
